(19) United States
(12) Patent Application Publication
(10) Pub. No.: US 2014/0192898 A1
(43) Pub. Date: Jul. 10, 2014

(54) CODING UNIT BIT NUMBER LIMITATION

(71) Applicant: Intel Corporation, Santa Clara, CA (US)

(72) Inventors: Wenhao Zhang, Beijing (CN); Yi-Jen Chiu, San Jose, CA (US); Lingzhi Liu, San Jose, CA (US); Lidong Xu, Beijing (CN); Yu Han, Beijing (CN); Zhipin Deng, Beijing (CN); Xiaoxia Cai, Beijing (CN); Hong Jiang, El Dorado Hills, CA (US)

(21) Appl. No.: 13/977,668

(22) PCT Filed: Mar. 28, 2013
(86) PCT No.: PCT/US2013/034264

§ 371 Date: Jun. 28, 2013

Related U.S. Application Data
(60) Provisional application No. 61/748,907, filed on Jan. 4, 2013.
(60) Provisional application No. 61/770,699, filed on Feb. 28, 2013.

(51) Int. Cl. H04N 19/46

(52) U.S. Cl. CPC H04N 19/00545
USPC 375/240.26

(57) ABSTRACT

Systems, devices and methods related to video coding including a coding unit bit number limitation are described.

### RELATED APPLICATIONS

The present application claims the benefit of U.S. Provisional Application No. 61/748,907 filed Jan. 4, 2013, titled “MODE CONSTRAINED CODED BIT NUMBER LIMITATION”, and U.S. Provisional Application No. 61/770,699 filed Feb. 28, 2013, titled “MODE CONSTRAINED CODED BIT NUMBER LIMITATION”.

### BACKGROUND

High Efficiency Video Coding (HEVC), currently under development by the Joint Collaborative Team on Video Coding (JCT-VC) formed by ISO/IEC Moving Picture Expert Group (MPEG) and ITU-T Video Coding Experts Group (VCEG), is a video compression standard expected to be finalized in 2013. Similar to previous video coding standards, HEVC includes basic functional modules such as intra/inter prediction, transform, quantization, in-loop filtering, and entropy coding. HEVC defines a Largest Coding Unit (LCU) for a picture that is then partitioned into Coding Units (CUs) that take the form of rectangular blocks having variable sizes. A CU contains a square block of Luma pixels and two corresponding blocks of Chroma pixels. The size of a CU may be configured to be 8×8, 16×16, 32×32 or 64×64 in Luma component. The LCU is considered to be the basic unit when implementing the HEVC codec.

To reduce decoder complexity, HEVC constrains the bit number of any coded LCU to a limiting value. Because of the LCU bit number limit, a decoder knows the worst case bit size of a coded LCU and it may allocate a buffer of sufficient size to accommodate decoding of any sized LCU as long as it does not exceed the bit number limit. However, care should be taken in choosing the limiting bit number value because while larger limit values may significantly reduce the possibility that the coded LCU violates the constraint, they also increase decoder memory resource requirements. In a recent draft of the HEVC specification (see ISO/IEC JTC/SC29/WG11 and ITU-T SG16 WP3, “High efficiency video coding (HEVC) text specification draft 9” (JCTVC-J1003_d9), October 2012) the bit number limit value (LCUBitNumLimit) was set to a single specific ratio of the uncompressed raw data bit number (LCURawDataNum) of a LCU as follows in equation (1) and equation (2):

LCURawDataNum=sizeY*sizeY*bitdepthY+2*sizeC*sizeC*bitdepthC (1)

LCUBitNumLimit=( 4/3)*LCURawDataNum (2)

where sizeY and bitdepthY are the block size and bit depth respectively of the LCU's Luma component, and sizeC and bitdepthC are the block size and bit depth respectively of the LCU's Chroma component.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is an illustrative diagram of an example video coding scheme;

FIG. 3 is a flow diagram illustrating an example process;

FIG. 4 is an illustrative diagram of an example video coding system;

FIG. 5 is an illustrative diagram of an example system;

FIG. 6 illustrates an example device;

FIG. 7 is a flow diagram illustrating an example process;

FIG. 8 is a flow chart illustrating an example video coding process;

FIG. 9 is an illustrative diagram of an example video coding process in operation; and

FIG. 10 is an illustrative diagram of an example video coding system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Systems, apparatus, articles, and methods are described below related to video coding including a coding unit bit number limitation are described.

As described above, in video coding, the bit number of any coded largest coding unit (LCU) may be constrained to a limiting value (e.g., LCU bit number limit). Based on the LCU bit number limit, a decoder may be configured to allocate a buffer of sufficient size to accommodate the bit number limit, for example. In general, a larger bit number limit may reduce the possibility that a coded LCU violates the constraint. Violating a constraint at the encoder may cause the encoder to enter an intra block pulse code modulation (I_PCM) mode, which does not apply compression (e.g., raw data is directly sent) and is generally excluded from the standard encoder pipeline. A violation may therefore cause the encoder to pause the encoder pipeline and initiate an I_PCM branch. Such operations may significantly harm encoder performance and, in general, a larger bit number limit may be desirable at the encoder. However, care should be taken in choosing the limiting bit number value because while larger limit values may significantly reduce the possibility that the coded LCU violates the constraint as discussed, a larger bit number limit may increase the decoder memory resource requirements (e.g., allocated buffer size), as discussed. Therefore, choosing a LCU bit number limit may be an important factor in video coding and may impact performance at an encoder, a decoder, or both.

As will be described in greater detail below, techniques for choosing and implementing a LCU bit number limit are described. In some examples, the LCU bit number limit (e.g., a bit number limit for or associated with a video data block) may be determined based on a coding mode of a video coder. For example, based on an active video coding mode, a bit number limit scaling factor may be determined from multiple bit number limit scaling factors, and the bit number limit scaling factor may be multiplied by a raw video data size of the video data block to determine the bit number limit. In general, coding modes that tend to produce fewer bits may have a smaller bit number limit scaling factor while coding modes that tend to produce more bits may have a larger bit number limit scaling factor. In general, the bit scaling limit factor may be in the range of about 1 to 2, as is discussed further herein. At the encoder, the implementation of such techniques may reduce the frequency of violations of video data block coding constraints and, at the decoder, such techniques may limit or reduce the amount of memory (e.g., buffer size) dedicated to the video data block.

In other examples, the bit number limit scaling factor may be predetermined to have a value of 5/3, which may applied for all coding modes. In such examples, the bit number limit for or associated with a largest coding unit (LCU) of video data may be determined by multiplying a largest coding unit raw data number and the bit number limit scaling factor of 5/3. The video data may be coded based on the determined bit number limit. Such implementations may again offer reduced violations at the encoder and limiting dedicated memory at the decoder, while offering the further advantage of simplicity of implementation.

As used herein, the term “coder” may refer to an encoder and/or a decoder. Similarly, as used herein, the term “coding” may refer to performing video encoding via an encoder and/or performing video decoding via a decoder. For example a video encoder and video decoder may both be examples of coders capable of coding video data. In addition, as used herein, the term “codec” may refer to any process, program or set of operations, such as, for example, any combination of software, firmware, and/or hardware, that may implement an encoder and/or a decoder.

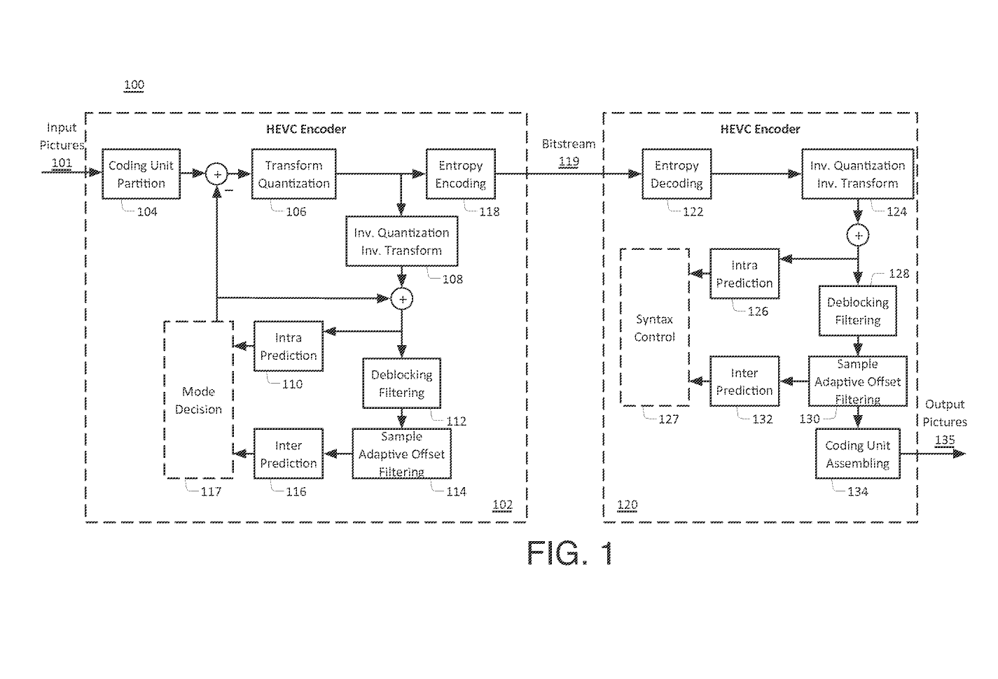

FIG. 1 is an illustrative diagram of an example video coding system 100, arranged in accordance with at least some implementations of the present disclosure. In various implementations, system 100 may undertake video compression and decompression and/or implement video codecs according to one or more standards or specifications, such as, for example, the High Efficiency Video Coding (HEVC) standard (see ISO/IEC JTC/SC29/WG11 and ITU-T SG16 WP3, “High efficiency video coding (HEVC) text specification draft 8” (JCTVC-J1003_d7), July 2012). Although system 100 and/or other systems, schemes or processes may be described herein in the context of the HEVC standard, the present disclosure is not limited to any particular video encoding standard or specification or extensions thereof.

The HEVC standard specifies that a picture may be partitioned into non-overlapping Largest Coding Units (LCUs) and each LCU may then be partitioned into Coding Units (CUs) that take the form of rectangular blocks having variable sizes. Within each LCU, a quad-tree based splitting scheme specifies the CU partition pattern. HEVC also defines Prediction Units (PUs) and Transform Units (TUs) that specify how a given CU is to be partitioned for prediction and transform purposes, respectively. A CU ordinarily includes one luma Coding Block (CB) and two chroma CBs together with associated syntax, and a PU may be further divided into Prediction Blocks (PBs) ranging in size from 64×64 samples down to 4×4 samples. As used herein, the term “block” may refer to any partition or sub-partition of a video picture. For example, a block may refer to video data corresponding to an LCU, a PU, a PB, a TU, or a CU.

As illustrated, system 100 may include an encoder 102 and a decoder 120. After processing input pictures with a coding unit partition module 104, encoder 102 may encode input pictures 101 using a coding loop that may include a transform and quantization module 106, an inverse quantization and inverse transform module 108, and, depending on the mode decision implemented by encoder 102 via mode decision module 117, either a first path including an intra prediction module 110, or a second path including a deblocking filtering module 112, a sample adaptive offset filtering module 114 and an inter prediction module 116. After transforming input pictures 101, encoder 102 may entropy encode the compressed images using entropy encoding module 118. Finally, encoder 102 may produce bitstream 119 that incorporates the coded video data. The functionality of modules 104, 106, 108, 110, 112, 114, 116, 117, and 118 are well recognized in the art and will not be described in any greater detail herein.

Decoder 120 may receive coded video data in the form of bitstream 119 and may, after processing the data with an entropy decoding module 122 and an inverse quantization and inverse transform module 124, may decode the resulting data using a decoding loop employing, depending on the coding mode indicated in syntax of bitstream 119 and implemented via syntax control module 127, either a first path including an intra prediction module 126 or a second path including a deblocking filtering module 128, a sample adaptive offset filtering module 130, and an inter prediction module 132. Decoder 120 may then employ a coding unit assembling module 134 to generate decoded output pictures 135, which may be presented to a user via a display, for example. The functionality of modules 122, 124, 126, 127, 128, 130, 132, and 134 are well recognized in the art and will not be described in any greater detail herein.

While FIG. 1 illustrates system 100 as employing particular encoding and decoding modules, various other coding modules or components not depicted in FIG. 1 for the sake of clarity may also be utilized in accordance with the present disclosure. Further, the present disclosure is not limited to the particular components illustrated in FIG. 1 and/or to the manner in which the various components of system 100 are arranged. Various components of the systems described herein may be implemented in software, firmware, and/or hardware and/or any combination thereof. For example, various components of system 100 may be provided, at least in part, by hardware of a computing System-on-a-Chip (SoC) such as may be found in a computing system such as, for example, a mobile phone.

Further, it may be recognized that encoder 102 of system 100 may be associated with and/or provided by a content provider system including, for example, a video content server system, and that bitstream 119 may be transmitted or conveyed to decoder 120 by various communications components and/or systems such as transceivers, antennae, network systems and the like not depicted in FIG. 1. It may also be recognized that decoder 120 may be associated with a client system such as a computing device (e.g., a desktop computer, laptop computer, tablet computer, convertible laptop, mobile phone or the like) that is remote to encoder 102 and that receives bitstream 119 via various communications components and/or systems such as transceivers, antennae, network systems and the like not depicted in FIG. 1. Therefore, in various implementations, encoder subsystem 101 and decoder subsystem 103 may be implemented either together or independent of one another. Further, while systems, apparatus and methods are described herein may refer to input and output pictures and video data blocks and the like, the present disclosure is not limited in this regard and the discussed techniques may be performed on frames or any suitable component of video data such as, for example, a sequence, a layer, a picture, a slice, or a block.

In accordance with the present disclosure, as will be explained in greater detail below, in the process of coding, in some implementations, video data encoder 102 may select from various bit number limit values and may associate the selected value with blocks of video data. In various implementations, the blocks may be LCUs. In some examples, encoder 102 may associate different ones of various bit number limit values with coded LCUs depending on which coding modes encoder 102 used to encode the video data. In doing so, an encoder may assign a higher bit number limit value to LCUs when the particular set of coding modes employed will be more likely to generate more bits. For instance, encoder 102 may assign a higher bit number limit to an LCU if it employed all the coding modes in the HEVC main profile except for the transform skipping mode while encoder 102 may assign a lower bit number limit if it used all the coding modes in the HEVC main profile including the transform skipping mode.

In some implementations, video data encoder 102 and/or video data decoder 120 may determine a bit number limit by determining a bit number limit scaling factor from multiple bit number limit scaling factors. The determination of the bit number limit scaling factor from the multiple bit number limit scaling factors may be based on an active video coding mode of video data encoder 102, and the bit number limit may be determined based on the bit number limit scaling factor. For example, the bit number limit may be determined by multiplying the bit number limit scaling factor and a raw video data size of the video data block. Such techniques may be applied at both video data encoder 102 and video data decoder 120 via a profile or table applied at both encoder 102 and decoder 120 via a standard, for example.

In other examples, video data encoder 102 may encode, via bitstream 119, the multiple bit number limit scaling factors and corresponding coding modes. As is discussed further below, the bit number limit scaling factors and corresponding coding modes may be included in a portion of a Supplemental Enhancement Information (SEI) package of bitstream 119. In such examples, video data encoder 102 may customize the combinations of coding modes and corresponding bit number limit scaling factor values and thereby manage the constraints and details of limitations in the coding process. Video data decoder 120 may then implement the received coding modes and corresponding bit number limit scaling factor values as discussed herein. In some examples, if not otherwise specified, a default bit number limit scaling factor may be used. In various examples, the default bit number limit scaling factor may be 3/2 or 5/3 or the like.

In some implementations, video data encoder 102 and/or video data decoder 120 may implement a bit number limit scaling factor having a predetermined value of 5/3 that may applied for all coding modes. In such examples, the bit number limit for or associated with a largest coding unit (LCU) of video data (e.g., LUCBitNumLimit) may be determined by multiplying a largest coding unit raw data number (e.g., as determined via equation (1) above as LCURawDataNum) and the bit number limit scaling factor of 5/3 as shown in equation (3):

LCUBitNumLimit=( 5/3)*LCURawDataNum (3)

The video data may be coded based on the determined bit number limit as discussed herein at video data encoder 102 and/or video data decoder 120.

As used herein the phrase “coding mode” refers to one of various compression modes that an encoder may employ to compress video data including, but not limited to, an intra mode, an inter mode, a transform skipping mode, and so forth. As those skilled in the art will recognize, by employing a transform skipping mode an encoder may use less bits to code some video data and, correspondingly, a decoder may employ a smaller buffer size to store the coded video data. In various examples, as discussed further below, the coding mode may include all coding modes in an HEVC main profile with transform skipping enabled, all coding modes in an HEVC main profile with transform skipping disabled, all coding modes in an HEVC main still picture profile with transform skipping enabled, all coding modes in an HEVC main still picture profile with transform skipping disabled, all coding modes in an HEVC main 10 profile with transform skipping enabled, or all coding modes in an HEVC main 10 profile with transform skipping disabled, or the like.

In general, an HEVC main profile may include a profile for coding I (intra-coded), P (predicted), or B (bi-predictive) pictures while an HEVC main still picture profile may include a profile for coding only I pictures such that the HEVC main still picture profile may be a subset of the HEVC main profile. Further, an HEVC main profile may include a profile for coding with a bit depth of 8 bits while an HEVC main 10 profile may include a profile for coding with a bit depth of 10 bits, for example.

In general, in accordance with the present disclosure, a variety of scaling factors may be selected based on the coding modes used by an encoder or a decoder, as discussed.

The selected scaling factor(s) may then be used to assign a bit number limit based on equation (4):

LCUBitNumLimit=scale_factor(coding modes)*LCURawDataNum (4)

where scale_factor (•) represents a function that maps the coding mode sets to a rational number in the range of [1.0, 2.0] or (1.0, 2.0] or the like. The usage of scale_factor (•) may be described in a mapping-table based manner. For example, determining a bit number limit scaling factor may include accessing a table having multiple bit number limit scaling factors and corresponding coding modes. Firstly, all the possible coding modes may be managed into several sets where each set is assigned an entry index in the mapping table. Then specific numbers may be assigned to all the entries.

For instance, the following table illustrates an example scaling factor mapping:

TABLE 1
General Example of Scaling Factor Mapping

| Index | Coding mode set | Scaling factor value |
|---|---|---|
| 1 | Coding mode combination #1 | scaling_factor_#1 |
| 2 | Coding mode combination #2 | scaling_factor_#2 |
| 3 | Coding mode combination #3 | scaling_factor_#3 |
| . . . | . . . | . . . |

Thus, depending on the coding mode combination employed to compress images (or video data in general), encoder 102 or decoder 120 may assign, specify or select a different scaling factor. As one non-limiting example, the following table illustrates a specific example scaling factor mapping:

TABLE 2
Specific Example of Scaling Factor Mapping.

| Index | Coding mode set | Scaling factor value |
|---|---|---|
| 1 | All HEVC main profile coding modes | 4/3 |
| 2 | All HEVC main profile coding modes except | 3/2 |
| | for transform skipping | |
| 3 | All HEVC main still picture profile coding | 4/3 |
| | modes | |
| 4 | All HEVC main still picture profile coding | 3/2 |
| | modes except for transform skipping | |
| 5 | All HEVC main 10 profile coding modes | 5/3 |
| 6 | All HEVC main 10 profile coding modes | 5/3 |
| | except for transform skipping | |

As shown in the non-limiting example of Table 2, encoder 102 or decoder 120 may assign, specify or select a first index value when employing all HEVC main profile coding modes where the first index value corresponds to a scaling factor value of 4/3. By contrast, encoder 102 may assign, specify or select a second index value when employing all HEVC main profile coding modes except the transform skipping mode where the second index value corresponds to a scaling factor value of 3/2 (or 1.5). In addition, for coding modes in the HEVC main profile, regardless of whether or not those coding modes include the transform skipping mode, encoder 102 may assign, specify or select a second index value corresponding to a scaling factor value of 5/3. In various implementations the scaling factors employed may be any number greater than or equal to one and less than or equal to two. In other words, in various limitations, the scaling factors may have values spanning the range [1.0, 2.0] or (1.0, 2.0] or the like.

As discussed, a bit number limit scaling factor may be determined from multiple bit number limit scaling factors based on a coding mode. In general, any number and combination of coding modes and corresponding bit number scaling factors may be implemented. In some examples, the video data block being coded may include High Efficiency Video Coding (HEVC) video data. In such examples, a first coding mode may include all coding modes in an HEVC main profile with transform skipping enabled and a corresponding first bit number limit scaling factor may include 4/3, a second coding mode may include all coding modes in an HEVC main profile with transform skipping disabled and a corresponding second bit number limit scaling factor may include 3/2, a third coding mode may include all coding modes in an HEVC main still picture profile with transform skipping enabled and a corresponding third bit number limit scaling factor may include 4/3, a fourth coding mode may include all coding modes in an HEVC main still picture profile with transform skipping disabled and a corresponding fourth bit number limit scaling factor may include 3/2, a fifth coding mode may include all coding modes in an HEVC main 10 profile with transform skipping enabled and a corresponding fifth bit number limit scaling factor may include 5/3, and a sixth coding mode may include all coding modes in an HEVC main 10 profile with transform skipping disabled and a corresponding sixth bit number limit scaling factor comprises 5/3.

As discussed, in various implementations, scaling factors may be assigned in a predetermined manner to various video specification profiles and/or level sections. For example, the HEVC main profile may be assigned one scaling factor for determining an LCU bit number limit while the HEVC main 10 profile may be assigned a different scaling factor for determining an LCU bit number limit. Thus, depending on the type of coding applied to received video data (e.g., main profile or main 10 profile), a decoder may then apply the predetermined scaling factor to determine the corresponding LCU bit number limit using equation (3) and hence buffering requirements.

In other implementations, the scaling factor may be predetermined to have a value of 5/3 that may be applied regardless of coding modes employed. Thus, regardless of the type of coded video data received (e.g., main profile, main still picture profile, or main 10 profile, or the like), a decoder may apply the predetermined scaling factor of 5/3 to determine the corresponding LCU bit number limit using equation (3) and hence to determine buffering requirements.

As discussed, in various implementations scaling factors may be associated with coding modes and a determined or selected scaling factor may be used to determine a bit number limit. In other examples, bit number limits may be associated with corresponding coding modes and used directly to determine the bit number limit for or associated with a coding mode and video data block (such as, for example, an LCU). In such examples, the size of the raw data number for the video data block may be constant or assumed to be constant or the like.

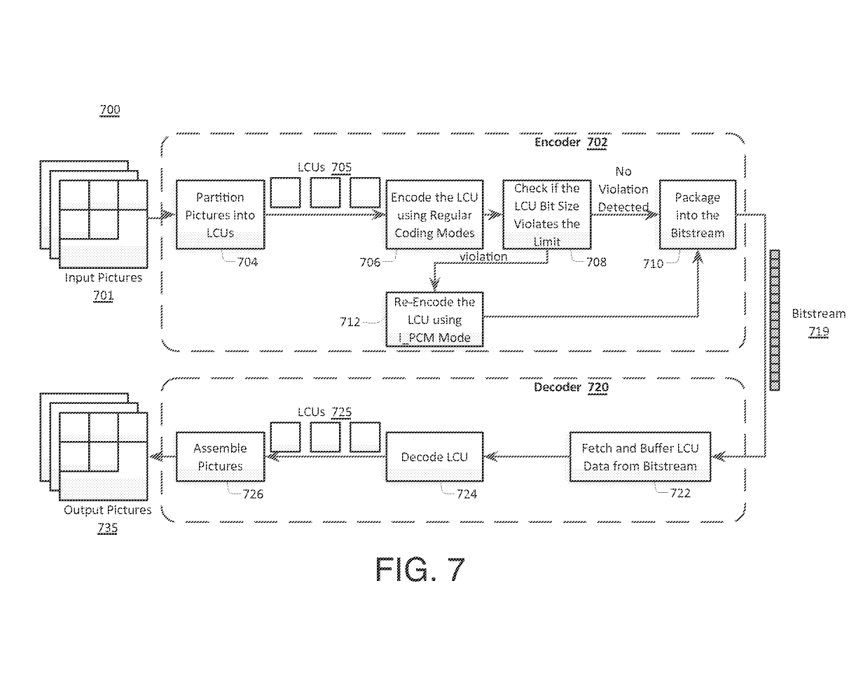

FIG. 7 is a flow diagram illustrating an example process, arranged in accordance with at least some implementations of the present disclosure. As shown, process 700 may be implemented via an encoder 702 and/or a decoder 720. Process 700 may include receiving input pictures 701 via encoder 702 and partitioning input pictures 701 into largest coding units (LCUs) 705 at block 704, “Partition Pictures into LCUs”. Although discussed with respect to input pictures 701 and LCUs 705, the techniques may be applied to any input video and video data blocks as discussed herein. LCUs 705 may be encoded via encoder 702 at block 706, “Encode the LCU using Regular Coding Modes” using regular or typical coding modes as discussed herein. Further, a bit number limit for LCUs 705 may be applied as discussed. In some examples, a bit number limit for LCUs 705 may be determined based on a bit number limit scaling factor, which was determined from multiple bit number limit scaling factors based on the coding mode. In other examples, a bit number limit for LCUs 705 may be determined based on multiplying a LCU raw data number and a scaling factor of 5/3.

In any event, at block 708, “Check if the LCU Bit Size Violates the Limit”, the LCU bit size for coded LCUs 705 may be compared to the bit number limit. If a coded LCU has a fewer bits than the bit number limit (e.g., no violation has occurred), the coded LCU or LCUs may be encoded or packaged into a bitstream 719 at block 710, “Package into the Bitstream”. If a coded LCU has more bits than the bit number limit (e.g., a violation has occurred), the violating LCU may be re-encoded using an intra block pulse code modulation (I_PCM) mode at block 712, “Re-Encode the LCU using I_PCM Mode”. The re-encoded LCU may be packaged into bitstream 719 at block 710. As discussed, the I_PCM module does not apply compression (e.g., raw data is directly sent) and is generally excluded from the standard encoder pipeline. Therefore, a violation at block 708 may cause encoder 702 to pause the standard encoder pipeline and initiate an I_PCM branch. Such operations may significantly harm the performance of encoder 702.

Process 700 may continue at block 722, “Fetch and Buffer LCU Data from Bitstream” such that received bitstream 719 may be received and LCU data may be fetched and buffered from bitstream 719. Further, as discussed herein, in some examples, bitstream 719 may include bit number scaling factors and corresponding coding modes and, in other examples, bit number scaling factors and corresponding coding modes may be implemented directly via decoder 720. Further, in some examples a constant scaling factor may be applied, such as a scaling factor of 5/3. In any event, at decoder 720, the bit number scaling factor and LCU bit number limit may determine a dedicated or allocated buffer size, as discussed. If the LCU bit number limit is too large, the performance of decoder 720 may be negatively impacted or, in general, decoder 720 may implement unnecessary and costly memory resources. As shown, at block 724, “Decode LCU”, the LCU data may be decoded to generate LCUs 725, which may be assembled at block 726, “Assemble Pictures”, to generate output pictures 735. Output pictures 735 may be presented to a user via a display device, for example.

As discussed, FIG. 7 illustrates an example process 700. FIG. 7 also illustrates the importance of selecting a bit number limit for a video coding block. As discussed, a bit number limit that is too small may cause poor performance at encoder 702 while a bit number limit that is too large may cause poor performance at decoder 720, for example.

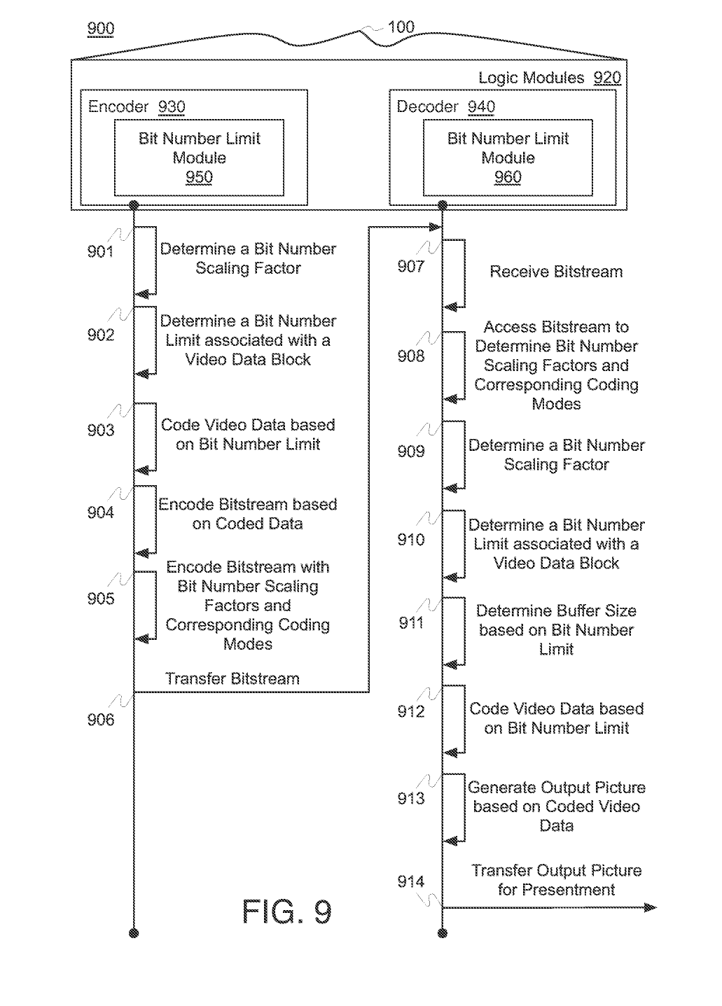

As discussed, in some implementations, a determination of a scaling factor and a video data block bit number limit may be determined using the same or similar techniques at both an encoder and a decoder. In some examples, a constant scaling factor (e.g., a scaling factor of 5/3) may be used while in other examples, a scaling factor may be determined, based on a coding mode, from multiple scaling factors. In other implementations, an encoder may encode a bitstream with the multiple bit number limit scaling factors and corresponding coding modes such that the decoder may use the provided information to implement scaling factors and bit number limits as discussed herein and, in particular, with respect to FIG. 9 below. In yet other implementations, an encoder may provide information to a decoder informing the decoder of which scaling factor the encoder has assigned, specified or selecting for any particular coded video data.

In other implementations, an encoder may place an indicator, message or portion thereof in a bitstream or portion thereof that the encoder provides to a decoder. The decoder may then use that information to identify the selected scaling factor and may then use equation (4) to determine the LCU bit number limit and a corresponding buffer size for storing the coded video data.

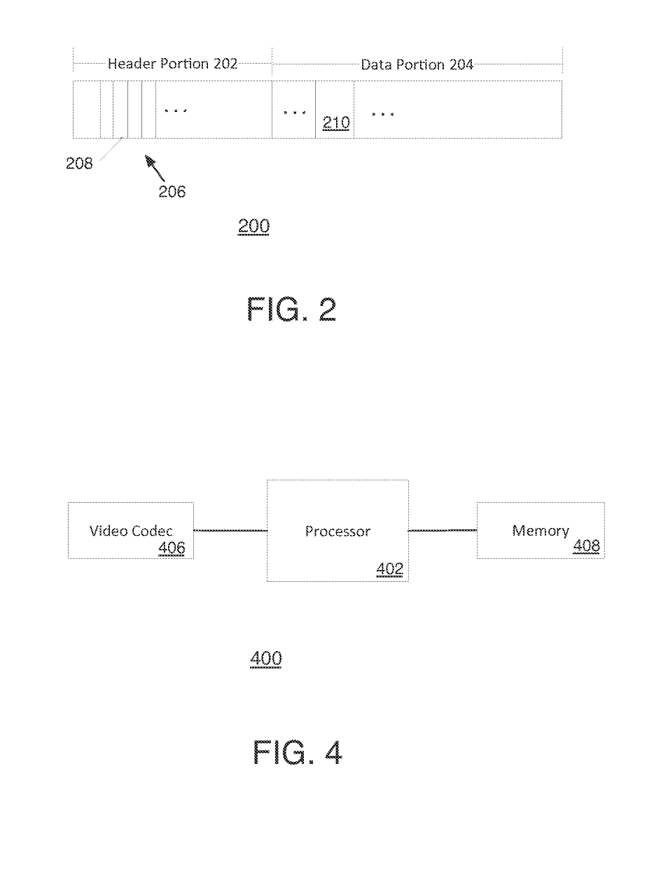

Thus, referring again to FIG. 1, encoder 102 may include an indicator, message or portion thereof in bitstream 119 or a portion thereof to inform decoder 120 of the selected scaling factor(s) associated with various portions of the coded video data conveyed by bitstream 119. FIG. 2 is an illustrative diagram of an example video coding scheme, arranged in accordance with at least some implementations of the present disclosure. For instance, FIG. 2 illustrates an example bitstream 200, such as bitstream 119, in accordance with the present disclosure. As depicted in FIG. 2, bitstream 200 may include a header portion 202 and a data portion 204. Header portion 202 may include one or more indicators 206. For instance, indicators 206 may include an indicator 208 whose value corresponds to the index value (discussed with respect to the tables above) and hence a particular scaling factor as described herein, for one or more blocks of coded video data such as LCUs. In various implementations, header portion 202 and/or data portion 204 may include data package 210, such as a Supplemental Enhancement Information (SEI) package, that may include the indicator specifying the selected scaling factor.

As discussed, in some examples, an encoder may encode a bitstream with the multiple bit number limit scaling factors and corresponding coding modes such that the decoder may use the provided information to implement scaling factors (e.g., based on corresponding coding modes being active) and bit number limits (e.g., by multiplying a scaling factor and a raw video data size) as discussed. With reference to FIG. 1, encoder 102 may encode bitstream 119 with the multiple bit number limit scaling factors and corresponding coding modes. For example, bitstream 200 as depicted in FIG. 2, may include data package 210, which may include the multiple bit number limit scaling factors and a corresponding coding modes. For example, the bit number limit scaling factors and corresponding coding modes may be provided as a Supplemental Enhancement Information (SEI) package or a portion of a Supplemental Enhancement Information (SEI) package in bitstream 200.

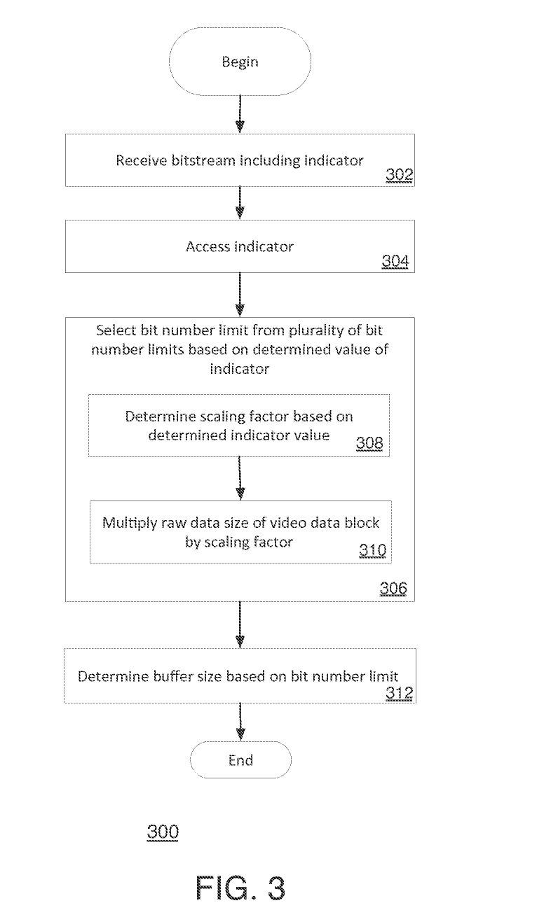

FIG. 3 illustrates a flow diagram of an example process 300(according to various implementations of the present disclosure. Process 300 may include one or more operations, functions or actions as illustrated by one or more of blocks 302, 304, 306, 308. 310, and 312 of FIG. 3. By way of non-limiting example, process 300 (may form at least part of a video decoding process as undertaken by decoder system 120 of FIG. 1.

Further, process 300 will also be described herein in reference to video coding system 400 of FIG. 4 where system 400 includes processor 402, video codec module 406, and memory 408. Processor 402 may instantiate codec module 406 to provide for video coding processes in accordance with the present disclosure. In the example of system 400, memory 408 may store video content including coded video data such as LCUs. Codec module 406 may implement an HEVC codec provided by any combination of software, firmware, and/or hardware. Memory 408 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 408 may be implemented by cache memory.

Returning to discussion of FIG. 3, process 300 may begin at block 302, “Receive bitstream including indicator”, where a bitstream may be received where that bitstream includes an indicator specifying a scaling factor (e.g., the indicator is a portion of the bitstream). For example, the indicator may be a bitstream flag or a portion of a Supplemental Enhancement Information (SEI) package or the like. The indicator may then be accessed at block 304, “Access indicator”, to determine a value of the indicator. For example, decoder 120 may receive bitstream 119 at block 302 where bitstream 119 includes an indicator such as indicator 208 of FIG. 2. For example, the indicator may have different values corresponding to index values of a mapping table as described above such that each value of the indicator (and corresponding coding mode) may correspond to a different one of a plurality of bit number limits. The indicator may be associated with a video data block such as, for example, a largest coding unit (LCU).

Process 300 may continue at block 306, “Select bit number limit from plurality of bit number limits based on determined value of indicator”, where bit number limit may be selected from a plurality of bit number limits based on the determined value of the indicator. As described previously, decoder 120 may undertake block 306 by determining a scaling factor based on the determined indicator value (block 308, “Determine scaling factor based on determined indicator value”) and then multiplying a raw data size of the video data block by the scaling factor (block 310, “Multiply raw data size of video data block by scaling factor’) using equation (4). For instance, referring to the non-limiting example of Table 2, if the indicator value specified an index value of one then the corresponding scaling factor would be 4/3, if the indicator value specified an index value of two then the corresponding scaling factor would be 3/2, and if the indicator value specified an index value of five then the corresponding scaling factor would be 5/3, and so on. In general, the scaling factor may have any suitable value such as, for example, a number equal to or greater than one and less than or equal to two, 3/2, 4/3, or 5/3, or the like.

Process 300 may then conclude at block 312, “Determine buffer size based on bit number limit”, with the decoder determining a buffer size based on the bit number limit (e.g., the selected bit number limit). For instance, for a given raw video data size, a larger scaling factor would result in determining a higher bit number limit at block 306 and a correspondingly larger buffer size at block 312, while a smaller scaling factor would result in a correspondingly smaller buffer size at block 312.

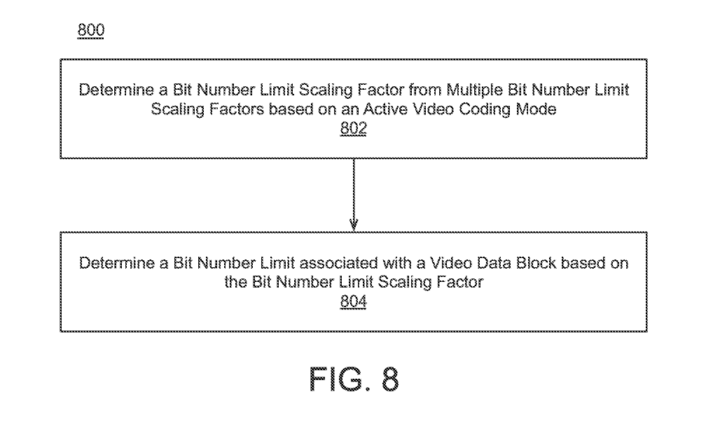

FIG. 8 is a flow chart illustrating an example video coding process 800, arranged in accordance with at least some implementations of the present disclosure. In the illustrated implementation, process 800 may include one or more operations, functions or actions as illustrated by one or more of blocks 802 and/or 804. By way of non-limiting example, process 800 will be described herein with reference to example video coding system 100. Process 800 may be directed, in general, to coding such that the concepts and/or operations described may be applied in the same or similar manner to encoding and/or decoding.

Process 800 may be utilized as a computer-implemented method for performing video coding. Process 800 may begin at operation 802, “Determine a Bit Number Limit Scaling Factor from Multiple Bit Number Limit Scaling Factors based on an Active Video Coding Mode”, where a bit number limit scaling factor may be determined from a plurality of bit number limit scaling factors based at least in part on an active video coding mode. For example, encoder 102 or decoder 120 may determine the bit number limit scaling factor. In some examples, determining the bit number limit scaling factor may include accessing a table (e.g., Table 1 or Table 2) having multiple of bit number limit scaling factors and corresponding coding modes. In some examples, a bit number limit scaling factor of 5/3 may be used for all coding modes. Further, in some examples, it may be determined an active coding mode is not available via the table and, in such examples, the bit number limit scaling factor may be set to a default bit number limit scaling factor. In general, the bit number scaling factor may be any suitable value such as, for example, a number equal to or greater than one and less than or equal to two, 3/2, 4/3, or 5/3, or the like.

Processing may continue from operation 802 to operation 804, “Determine a Bit Number Limit associated with a Video Data Block based on the Bit Number Limit Scaling Factor”, where a bit number limit for a video data block may be determined based at least in part on the bit number limit scaling factor. For example, encoder 102 or decoder 120 may determine the bit number limit. In some examples, determining the bit number limit for or associated with the video data block may include multiplying the bit number limit scaling factor and a raw video data size of the video data block (e.g., as shown in equation (4)). As discussed, in some examples, the bit number limit scaling factor may be 5/3 for all coding modes and, in such examples, the bit number limit for a largest coding unit of video data may be determined by multiplying a largest coding unit raw data number and a bit number limit scaling factor of 5/3.

In general, encoder 102 and/or decoder 120 may code the video data based on the determined bit number limit. At encoder 102, the coded video data may be encoded in bitstream 119. At decoder 120, the coded video data may be used to generate output pictures, which may be presented to a user via a display device, for example.

In general, process 800 may be repeated any number of times for any number of video data blocks. Further, process 800 may be initiated upon a change in coding mode or periodically, or the like. The resultant bit number may be used to encode a bitstream or generate output pictures as discussed. Somme additional and/or alternative details related to process 800 may be illustrated in one or more examples of implementations discussed herein and, in particular, with respect to FIG. 9 below.

FIG. 9 is an illustrative diagram of example video coding system 900 and video coding process 900 in operation, arranged in accordance with at least some implementations of the present disclosure. In the illustrated implementation, process 900 may include one or more operations, functions or actions as illustrated by one or more of actions 901, 902, 903, 904, 905, 906, 907, 908, 909, 910, 911, 912, 913, and/or 914. By way of non-limiting example, process 900 will be described herein with reference to example video coding system 100 of FIG. 1.

In the illustrated implementation, video coding system 100 may include logic modules 920, the like, and/or combinations thereof. For example, logic modules 920, may include encoder 930 (which may correspond to encoder 102 or encoder 702, for example), which may include bit number limit module 950 and decoder 940, which may bit number limit module 960. Although video coding system 100, as shown in FIG. 9, may include one particular set of blocks or actions associated with particular modules, these blocks or actions may be associated with different modules than the particular module illustrated here. Although process 900, as illustrated, is directed to encoding and decoding, the concepts and/or operations described may be applied to encoding and/or decoding separately, and, more generally, to video coding.

Process 900 may begin at block 901, “Determine a Bit Number Scaling Factor”, where a bit number limit scaling factor may be determined from a plurality of bit number limit scaling factors based at least in part on an active video coding mode. For example, encoder 930 may determine the bit number limit scaling factor via bit number limit module 950. In some examples, determining the bit number limit scaling factor may include accessing a table (e.g., Table 1 or Table 2) having multiple of bit number limit scaling factors and corresponding coding modes. In other examples, a bit number limit scaling factor of 5/3 may be used for all coding modes.

Process 900 may continue from block 901 to block 902, “Determine a Bit Number Limit associated with a Video Data Block”, where a bit number limit for or associated with a video data block may be determined based at least in part on the bit number limit scaling factor. For example, encoder 930 may determine the bit number limit via bit number limit module 950. In some examples, determining the bit number limit for or associated with the video data block may include multiplying the bit number limit scaling factor and a raw video data size of the video data block (e.g., as shown in equation (4)). As discussed, in some examples, the bit number limit scaling factor may be 5/3 for all coding modes and, in such examples, the bit number limit for a largest coding unit of video data may be determined by multiplying a largest coding unit raw data number and a bit number limit scaling factor of 5/3 (e.g., as shown in equation (3)).

Process 900 may continue from block 902 to block 903, “Code Video Data based on Bit Number Limit”, where video data may be coded based at least in part on the bit number limit. For example, encoder 930 may encode video data based on the bit number limit.

Process 900 may continue from block 903 to block 904, “Encode Bitstream based on Coded Data”, where a bitstream may be encoded based at least in part on the coded video data. For example, encoder 930 may encode a bitstream included the data encoded at block 903. The encoded bitstream may correspond to bitstream 119 or bitstream 719, for example.

Process 900 may continue from block 904 to block 905, “Encode Bitstream with Bit Number Scaling Factors and Corresponding Coding Modes”, where multiple bit number limit scaling factors and corresponding plurality of coding modes may be encoded in the bitstream. In some examples, the bit number limit scaling factors and corresponding plurality of coding modes may be provided as a portion of a Supplemental Enhancement Information (SEI) package of the bitstream. As discussed, in some examples, a decoder may implement the described techniques using the information received via the bitstream. In other examples, a decoder may implement the described techniques using scaling factors and corresponding coding modes preloaded or predetermined at the decoder. In yet other examples, a constant scaling factor of 5/3 may be used. In such examples, block 905 may be skipped.

Process 900 may continue at 906, “Transfer Bitstream”, where the encoded bitstream may be transferred. As shown, the encoded bitstream may be transferred to a decoder 940. As discussed, encoder 930 may be associated with and/or be provided by a content provider system and decoder 940 may be associated with a client system. Therefore, in various implementations, encoder 930 and decoder 940 may be implemented substantially independent of one another. In various examples, the bitstream may be transferred via the Internet, via a memory device, or the like. As will be appreciated, in some implementations, the bitstream may be transferred to multiple devices either serially or in parallel.

Process 900 may continue from block 906 or begin at block 907, “Receive Bitstream”, where a bitstream associated with video data may be received at decoder 940.

Process 900 may continue from block 907 to block 908, “Access Bitstream to Determine Bit Number Scaling Factors and Corresponding Coding Modes”, where the received bitstream may be accessed to determine the plurality of bit number limit scaling factors and the corresponding plurality of coding modes. As discussed, in some examples, the bit number limit scaling factors and corresponding plurality of coding modes may be implemented via decoder 940 without being encoded in the bitstream. In such examples, block 908 may be skipped.

Process 900 may continue 909, “Determine a Bit Number Scaling Factor”, where a bit number limit scaling factor may be determined from a plurality of bit number limit scaling factors based at least in part on an active video coding mode. For example, decoder 940 may determine the bit number limit scaling factor via bit number limit module 960. In some examples, determining the bit number limit scaling factor may include accessing a table (e.g., Table 1 or Table 2) having multiple of bit number limit scaling factors and corresponding coding modes. In other examples, a bit number limit scaling factor of 5/3 may be used for all coding modes.

Process 900 may continue from block 909 to block 910, “Determine a Bit Number Limit associated with a Video Data Block”, where a bit number limit for or associated with a video data block may be determined based at least in part on the bit number limit scaling factor. For example, decoder 940 may determine the bit number limit via bit number limit module 950. In some examples, determining the bit number limit for or associated with the video data block may include multiplying the bit number limit scaling factor and a raw video data size of the video data block (e.g., as shown in equation (4)). As discussed, in some examples, the bit number limit scaling factor may be 5/3 for all coding modes and, in such examples, the bit number limit for a largest coding unit of video data may be determined by multiplying a largest coding unit raw data number and a bit number limit scaling factor of 5/3 (e.g., as shown in equation (3)).

Process 900 may continue from block 910 to block 911, “Determine Buffer Size based on Bit Number Limit”, where a buffer size may be determined based on the determined bit number limit. For example, decoder 940 may determine an allocated or dedicated memory buffer size that is equal to or similar to the determined bit number limit. In some examples, a buffer size may not be changed based on the bit number limit and, in such examples, block 911 may be skipped.

Process may continue at block 912, “Code Video Data based on Bit Number Limit”, where video data may be coded based at least in part on the bit number limit. For example, video decoder 940 may decode video data based on the bit number limit.

Process 900 may continue from block 912 to block 913, “Determine Buffer Size based on Bit Number Limit”, where an output picture or pictures may be generated based at least in part on the coding of the video data. For example, decoder 940 may generate output pictures based on the video data decoded at block 912.

Process 900 may continue from block 912 to block 913, “Transfer Output Picture for Presentment”, where the output picture may be transferred for presentment. For example, an output picture may be presented to a user via a display device. While implementation of example process 300, 700, 800, or 900 may include the undertaking of all blocks shown in the order illustrated, the present disclosure is not limited in this regard and, in various examples, implementation of process 300, 700, 800, or 900 may include the undertaking of only a subset of the blocks shown and/or in a different order than illustrated.

In addition, any one or more of the blocks discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the blocks of the example processes in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of system 100 and/or video codec module 406, or other systems or modules discussed herein.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

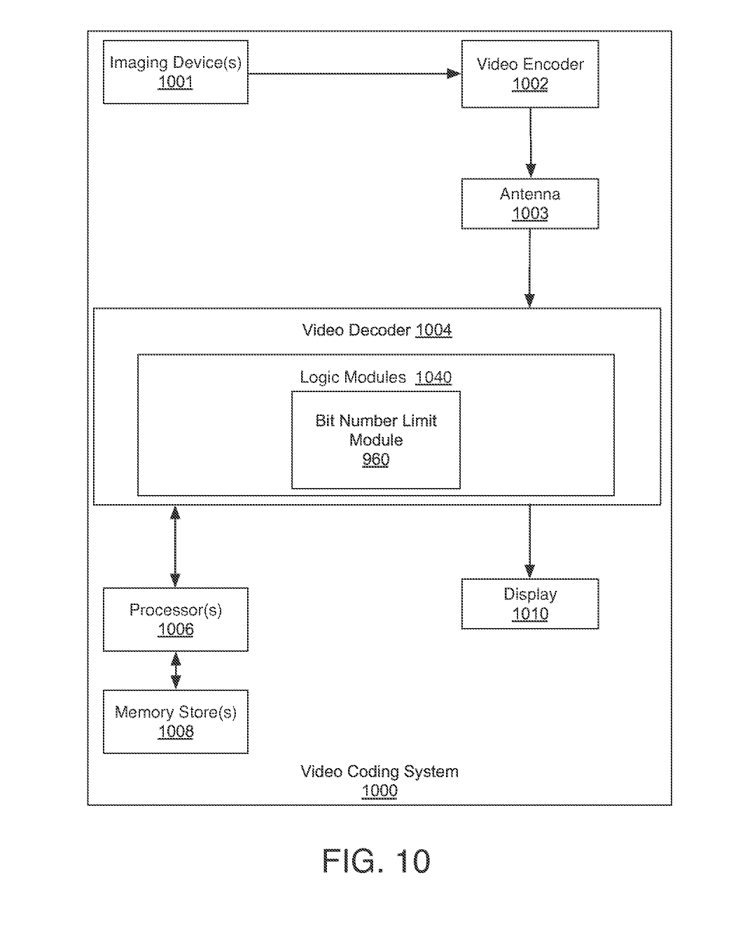

FIG. 10 is an illustrative diagram of an example video coding system 1000, arranged in accordance with at least some implementations of the present disclosure. In the illustrated implementation, video coding system 1000 may include imaging device(s) 1001, a video encoder 1002, an antenna 1003, a video decoder 1004, one or more processors 1006, one or more memory stores 1008, a display 1010, and/or logic modules 1040. Logic modules 1040 may include bit number limit module 960, the like, and/or combinations thereof. In some examples, video encoder 1002 may implement one or more logic modules including a bit number limit module such as bit number limit module 940, for example.

As illustrated, antenna 1003, video decoder 1004, processor 1006, memory store 1008, and/or display 1010 may be capable of communication with one another and/or communication with portions of logic modules 1040. Similarly, imaging device(s) 1001 and video encoder 1002 may be capable of communication with one another and/or communication with portions of logic modules 1040. Accordingly, video decoder 1004 may include all or portions of logic modules 1040, while video encoder 1002 may include similar logic modules. Although video coding system 1000, as shown in FIG. 10, may include one particular set of blocks or actions associated with particular modules, these blocks or actions may be associated with different modules than the particular module illustrated here.

In some examples, video coding system 1000 may include antenna 1003, video decoder 1004, the like, and/or combinations thereof. Antenna 1003 may be configured to receive an encoded bitstream of video data. Video decoder 1004 may be communicatively coupled to antenna 1003 and may be configured to decode the encoded bitstream. Video decoder 1004 may be configured to determine a bit number limit scaling factor from a plurality of bit number limit scaling factors based at least in part on an active video coding mode and determine a bit number limit for or associated with a video data block based at least in part on the bit number limit scaling factor or determine a bit number limit for or associated with a largest coding unit of video data by multiplying a largest coding unit raw data number and a bit number limit scaling factor of 5/3 and code the video data based at least in part on the bit number limit, as discussed herein.

In other examples, video coding system 1000 may include display device 1010, one or more processors 1006, one or more memory stores 1008, bit number limit module 960, the like, and/or combinations thereof. Display device 1010 may be configured to present video data such as output pictures. Processors 1006 may be communicatively coupled to display 1010. Memory stores 1008 may be communicatively coupled to the one or more processors 1006. Video decoder 1004 (or video encoder 1002 in other examples) may be communicatively coupled to the one or more processors 1006 and may be configured to determine a bit number limit scaling factor from a plurality of bit number limit scaling factors based at least in part on an active video coding mode, determine a bit number limit for or associated with a video data block based at least in part on the bit number limit scaling factor, and code the video data based at least in part on the bit number limit or determine a bit number limit for or associated with a largest coding unit of video data by multiplying a largest coding unit raw data number and a bit number limit scaling factor of 5/3 and code the video data based at least in part on the bit number limit, such that the presentment of image data via display device 1010 may be based at least in part on the coded video data.

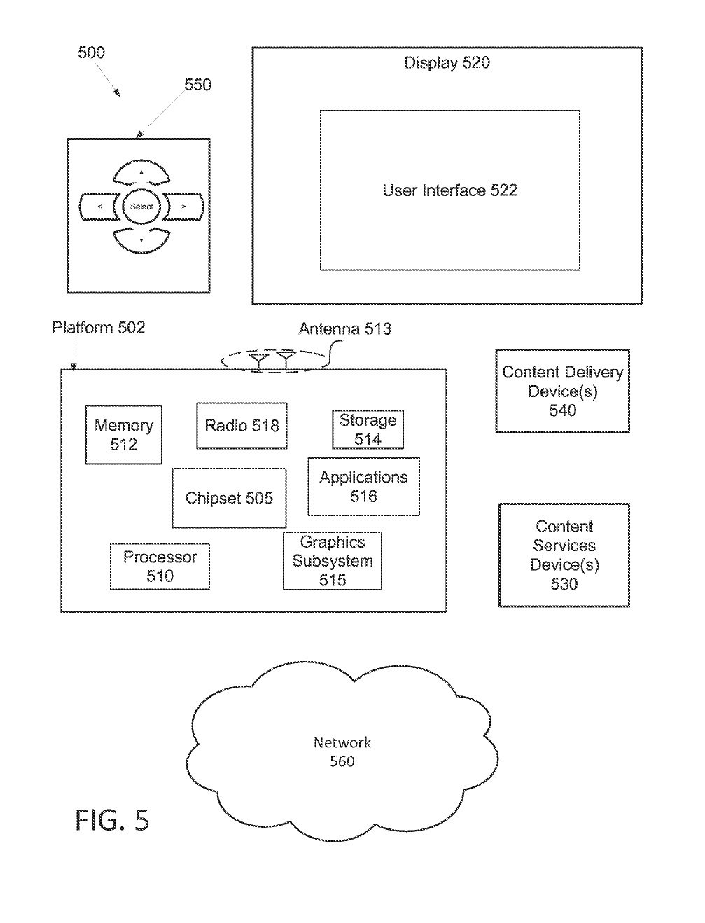

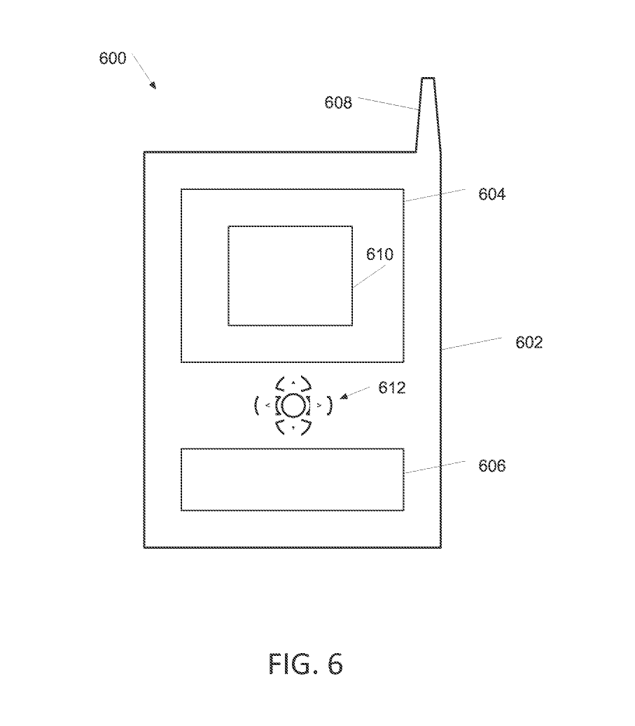

In various embodiments, bit number limit module 960 (and a bit number limit module implemented via encoder 1002, if present) may be implemented in hardware, while software may implement other logic modules. For example, in some embodiments, bit number limit module 960 may be implemented by application-specific integrated circuit (ASIC) logic while other logic modules may be provided by software instructions executed by logic such as processors 1006. However, the present disclosure is not limited in this regard and bit number limit module 960 (and a bit number limit module implemented via encoder 1002, if present) and/or other logic modules may be implemented by any combination of hardware, firmware and/or software. In addition, memory stores 1008 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1008 may be implemented by cache memory. FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, antenna 513, storage 514, graphics subsystem 515, applications 516 and/or radio 518. Chipset 505 may provide interconununication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone device communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In various embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In various embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off.” In addition, chipset 505 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 500 may be embodied in varying physical styles or form factors. FIG. 6 illustrates implementations of a small form factor device 600 in which system 600 may be embodied. In various embodiments, for example, device 600 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for performing video coding may include determining a bit number limit scaling factor from a plurality of bit number limit scaling factors based at least in part on an active video coding mode. A bit number limit may be determined for a video data block based at least in part on the bit number limit scaling factor.

In another example, a computer-implemented method for performing video coding may further include coding the video data based at least in part on the bit number limit. A bitstream may be encoded based at least in part on the coded video data. The plurality of bit number limit scaling factors and a corresponding plurality of coding modes may be encoded in the bitstream. The plurality of bit number limit scaling factors and the corresponding plurality of coding modes may be encoded as a portion of a Supplemental Enhancement Information (SEI) package of the bitstream. The bitstream may be received. The bitstream may be accessed to determine the plurality of bit number limit scaling factors and the corresponding plurality of coding modes. A buffer size may be determined based on the determined bit number limit. An output picture may be generated based at least in part on the coding of the video data. Determining the bit number limit scaling factor may include accessing a table including the plurality of bit number limit scaling factors and the corresponding plurality of coding modes. Determining the bit number limit scaling factor may include determining the active coding mode is not available via the table and the bit number limit scaling factor may be set to a default bit number limit scaling factor. Determining the bit number limit for the video data block may include multiplying the bit number limit scaling factor and a raw video data size of the video data block. The scaling factor may include a number equal to or greater than one and less than or equal to two, 3/2, 4/3, or 5/3. The plurality of coding modes may include a lower bit producing coding mode and a higher bit producing coding mode that produces more bits that the lower bit producing coding mode such that a bit number limit scaling factor associated with the lower bit producing coding mode may be less than a bit number limit scaling factor associated with the higher bit producing coding mode. The video data block may be a largest coding unit (LCU). The video data block may include High Efficiency Video Coding (HEVC) video data. A first coding mode may include all coding modes in an HEVC main profile with transform skipping enabled and a corresponding first bit number limit scaling factor may be 4/3. A second coding mode may include all coding modes in an HEVC main profile with transform skipping disabled and a corresponding second bit number limit scaling factor may be 3/2. A third coding mode may include all coding modes in an HEVC main still picture profile with transform skipping enabled and a corresponding third bit number limit scaling factor may be 4/3. A fourth coding mode may include all coding modes in an HEVC main still picture profile with transform skipping disabled and a corresponding fourth bit number limit scaling factor may be 3/2. A fifth coding mode may include all coding modes in an HEVC main 10 profile with transform skipping enabled and a corresponding fifth bit number limit scaling factor may be 5/3. A sixth coding mode may include all coding modes in an HEVC main 10 profile with transform skipping disabled and a corresponding sixth bit number limit scaling factor may be 5/3. Determining the bit number limit may include determining the bit number limit at a video decoder. The video decoder may be implemented, at least in part, in hardware. Determining the bit number limit may include determining the bit number limit at a video encoder. The video encoder may be implemented, at least in part, in hardware.

In yet another example, a computer-implemented method for performing video coding may include determining a bit number limit associated with a largest coding unit of video data by multiplying a largest coding unit raw data number and a bit number limit scaling factor of 5/3. The video data may be coded based at least in part on the bit number limit.

In another further example, a computer-implemented method for performing video coding may further include encoding a bitstream based at least in part on the coded video data. The bitstream may be received. A buffer size may be determined based on the determined bit number limit. An output picture may be generated based at least in part on the coding of the video data. The video data block may include High Efficiency Video Coding (HEVC) video data. Determining the bit number limit may include determining the bit number limit at a video decoder. The video decoder may be implemented, at least in part, in hardware. Determining the bit number limit may include determining the bit number limit at a video encoder. The video encoder may be implemented, at least in part, in hardware.

In another example, a system for video coding on a computer may include a display device, one or more processors, one or more memory stores, a video coder, the like, and/or combinations thereof. The display device may be configured to present video data. The one or more processors may be communicatively coupled to the display device. The one or more memory stores may be communicatively coupled to the one or more processors. The video encoder may be communicatively coupled to the one or more processors and configured to determine a bit number limit scaling factor from a plurality of bit number limit scaling factors based at least in part on an active video coding mode and determine a bit number limit associated with a video data block based at least in part on the bit number limit scaling factor. The presentment of image data via the display device may be based at least in part on the coded video data.

In a further example system, the video coder may be configured to encode a bitstream based at least in part on the coded video data, encode the plurality of bit number limit scaling factors and a corresponding plurality of coding modes in the bitstream wherein the plurality of bit number limit scaling factors and the corresponding plurality of coding modes comprise a portion of a Supplemental Enhancement Information (SEI) package of the bitstream, receive the bitstream, access the bitstream to determine the plurality of bit number limit scaling factors and the corresponding plurality of coding modes, determine a buffer size based on the determined bit number limit, and/or generate an output picture based at least in part on the coded video data. The video coder may be configured to determine the bit number limit scaling factor by accessing a table comprising the plurality of bit number limit scaling factors and the corresponding plurality of coding modes. The video coder may be configured to determine the bit number limit scaling factor by determining the active coding mode is not available via the table and wherein the bit number limit scaling factor is set to a default bit number limit scaling factor. The video coder may be configured to determine the bit number limit associated with the video data block by multiplying the bit number limit scaling factor and a raw video data size of the video data block. The scaling factor may include a number equal to or greater than one and less than or equal to two, 3/2, 4/3, or 5/3. The plurality of coding modes may include a lower bit producing coding mode and a higher bit producing coding mode that produces more bits that the lower bit producing coding mode such that a bit number limit scaling factor associated with the lower bit producing coding mode may be less than a bit number limit scaling factor associated with the higher bit producing coding mode. The video data block may be a largest coding unit (LCU). The video data block may include High Efficiency Video Coding (HEVC) video data. A first coding mode may include all coding modes in an HEVC main profile with transform skipping enabled and a corresponding first bit number limit scaling factor may be 4/3. A second coding mode may include all coding modes in an HEVC main profile with transform skipping disabled and a corresponding second bit number limit scaling factor may be 3/2. A third coding mode may include all coding modes in an HEVC main still picture profile with transform skipping enabled and a corresponding third bit number limit scaling factor may be 4/3. A fourth coding mode may include all coding modes in an HEVC main still picture profile with transform skipping disabled and a corresponding fourth bit number limit scaling factor may be 3/2. A fifth coding mode may include all coding modes in an HEVC main 10 profile with transform skipping enabled and a corresponding fifth bit number limit scaling factor may be 5/3. A sixth coding mode may include all coding modes in an HEVC main 10 profile with transform skipping disabled and a corresponding sixth bit number limit scaling factor may be 5/3. The video coder may include a video decoder. The video decoder may be implemented, at least in part, in hardware. The video coder may include a video encoder. The video encoder may be implemented, at least in part, in hardware.

In yet another example, a system for video coding on a computer may include a display device, one or more processors, one or more memory stores, a video coder, the like, and/or combinations thereof. The display device may be configured to present video data. The one or more processors may be communicatively coupled to the display device. The one or more memory stores may be communicatively coupled to the one or more processors. The video encoder may be communicatively coupled to the one or more processors and configured to determine a bit number limit associated with a largest coding unit of video data by multiplying a largest coding unit raw data number and a bit number limit scaling factor of 5/3 and code the video data based at least in part on the bit number limit. The presentment of image data via the display device may be based at least in part on the coded video data.

In another further example system, the video coder may be configured to encode a bitstream based at least in part on the coded video data, receive the bitstream, determine a buffer size based on the determined bit number limit, and/or generate an output picture based at least in part on the coding of the video data. The video data block may include High Efficiency Video Coding (HEVC) video data. The video coder may include a video decoder. The video decoder may be implemented, at least in part, in hardware. The video coder may include a video encoder. The video encoder may be implemented, at least in part, in hardware.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-50. (canceled)

51. An apparatus, comprising:
a video decoder to access a bitstream of compressed video data, the compressed video data including at least one coding unit of coded video data;
the video decoder to determine a bit number limit associated with the coding unit, wherein to determine the bit number limit the video decoder is to multiply a raw data size of the coding unit by a factor of ( 5/3).

52. The apparatus of claim 51, further comprising:
storage; wherein the video decoder is to determine a size of a buffer in the storage based at least in part on the determined bit number limit.

53. The apparatus of claim 52, wherein the video decoder is to store the coded video data in the buffer.

54. A system, comprising:
a video decoder to access a bitstream of compressed video data, the compressed video data including at least one coding unit of coded video data;
the video decoder to determine a bit number limit associated with the coding unit, wherein to determine the bit number limit the video decoder is to multiply a raw data size of the coding unit by a factor of ( 5/3); and
storage; wherein the video decoder is to determine a size of a buffer in the storage based at least in part on the determined bit number limit.

55. The system of claim 54, further comprising:
a display, wherein the video decoder is to decode the at least one coding unit to generate decoded video data; and
a processor to display the decoded video data on the display.

56. The system of claim 54, wherein the video decoder is to determine the raw data size by accessing at least one indicator in a syntax of the bitstream.

57. The system of claim 54, further comprising one or more radios to receive the bitstream.

58. A method, comprising:
accessing a bitstream of compressed video data, the compressed video data including at least one coding unit of coded video data; and
determining a bit number limit associated with the coding unit, wherein determining the bit number limit includes multiplying a raw data size of the coding unit by a factor of ( 5/3).

59. The method of claim 58, further comprising determining a buffer size based at least in part on the determined bit number limit.

60. The method of claim 58, further comprising:
decoding the at least one coding unit to generate decoded video data; and
displaying the decoded video data.

61. The method of claim 58, wherein determining the raw data size comprises accessing at least one indicator in a syntax of the bitstream.

62. At least one machine readable medium having stored thereon one or more instructions that, when executed by a computing device, causes the computing device to:
access a bitstream of compressed video data, the compressed video data including at least one coding unit of coded video data; and
determine a bit number limit associated with the coding unit, wherein to determine the bit number limit includes multiplying a raw data size of the coding unit by a factor of ( 5/3).

63. The at least one machine readable medium of claim 62, further having stored thereon one or more instructions that, when executed by the computing device, causes the computing device to determine a buffer size based at least in part on the determined bit number limit.

64. The at least one machine readable medium of claim 62, further having stored thereon one or more instructions that, when executed by the computing device, causes the computing device to:
decode the at least one coding unit to generate decoded video data; and
display the decoded video data.

65. The at least one machine readable medium of claim 62, wherein determining the raw data size comprises accessing at least one indicator in a syntax of the bitstream.

66. An apparatus, comprising:
a video encoder to generate at least one coding unit of coded video data, the video encoder to generate a bitstream including the at least one coding unit, the video encoder to generate syntax for the bitstream, wherein the syntax includes at least one indicator specifying a raw data size of the coding unit, wherein the indicator is to be accessed by a decoder so that the decoder may determine the raw data size and may allocate a buffer for buffering the coding unit wherein the buffer has a size of at least the raw data size multiplied by a factor of ( 5/3).

67. The apparatus of claim 66, further comprising one or more radios to transmit the bitstream.
